(19) United States
(12) Patent Application Publication
(10) Pub. No.: US 2021/0103873 A1
(43) Pub. Date: Apr. 8, 2021

(54) BLOCKCHAIN-BASED SLEEVE GROUTING QUALITY TRACING METHOD AND SYSTEM, AND COLLECTION TERMINAL

(71) Applicants: China Constuction Science & Technology Group Co., Ltd, SHENZHEN (CN); CHINA STATE COSTRUCTION ENGINEERING CORPORATION LIMITED, BEIJING (CN)

(72) Inventors: TAO ZENG, BEIJING (CN); HAISHAN GUO, BEIJING (CN); KANG LIU, BEIJING (CN); YUZHONG CAO, BEIJING (CN); HU QI, BEIJING (CN); LIMING LI, BEIJING (CN)

(21) Appl. No.: 17/054,771

(22) PCT Filed: Jul. 9, 2018
(86) PCT No.: PCT/CN2018/094992

§ 371 Date: Nov. 11, 2020

(30) Foreign Application Priority Data
May 28, 2018 (CN) 201810523488.4

(51) Int. Cl. G06Q 10/06; H04L 9/06; H04L 9/32; G06T 17/00

(52) U.S. Cl. CPC G06Q 10/06395; H04L 9/0643; H04L 2209/38; G06T 17/00; H04L 9/3247

(57) ABSTRACT

The present disclosure discloses a method and system for tracing a quality of sleeve grouting based on a blockchain and a gathering terminal, wherein the method includes: step S1: establishing a unified standard of quality tracing and a standard of a method of gathering data; step S2: by using a gathering terminal, based on a grouting event, gathering in batch relevant tracing information, and forming the data fingerprint of the event, to ensure the integrity and non-repudiation of the on-chain data; step S3: performing blockchain distributed bookkeeping to the tracing information of sleeve grouting and a result of casual inspection; and step S4: realizing quality tracing of sleeve grouting based on a unified tracing interface and a safe access policy. The present disclosure can effectively solve one of the bottlenecks that restrict the scale development of the industry in the industrialization of novel constructions.

### CROSS REFERENCE TO RELATED APPLICATIONS

This application is a 371 of International Patent Application No. PCT/CN2019/094992 with a filing date of Jul. 9th, 2018, designating the United States, now pending, and further claims priority to Chinese Patent Application No. 201810523488.4, filed on May 28th. 2018, the entire content of which is incorporated herein by reference.

### TECHNICAL FIELD

The present disclosure relates to the field of quality tracing in the industrialization of novel constructions, and particularly relates to a method and system for tracing a quality of sleeve grouting based on a blockchain and a gathering terminal.

### BACKGROUND

The quality management of sleeve grouting is one of the critical issues that can influence the scale development of prefabricated constructions. Currently, the records of the sleeve-grouting process are mostly paperwork with hand signatures, and the existing electronic data, including Word/Excel forms and the photographs/videos of the scenes, have mostly a function in formality rather than a practical function. They cannot effectively associate the key tracing information of the constructing project, the grouted site, the responsible personnel, the supervising personnel, the grouting quality and so on, and the data of grouting events are scattered, are incomplete, can be easily tampered, can be easily lost and have a poor traceability. At the current stage, under the general background of the lack of an effective approach of checking the quality of sleeve grouting, it is especially important for the sound and fast development of the industrialization of novel constructions to establish a system of quality tracing of sleeve grouting in which parties can participate. The following problems in quality tracing of sleeve grouting are urgently required to be solved: (1) lack of standards and methods of quality tracing of sleeve grouting; (2) lack of effective gathering methods and gathering devices of tracing information; (3) lack of high-efficiency gathering, self-validating ability, non-repudiation and tamper proof of tracing information; (4) lack of a data entrusting mechanism among the important participating parties and supervising parties of sleeve grouting; and (5) lack of a method for quality tracing in the process of constructing and quality tracing during the full life cycle of constructions of sleeve grouting. Therefore, a method of tracing in the overall process of constructing and tracing during the full life cycle of constructions of the quality of sleeve grouting is urgently needed.

### SUMMARY

The present disclosure seeks to solve the technical problem of realizing the tracing in the overall process of constructing and tracing during the full life cycle of constructions of the quality of sleeve grouting in the industrialization of novel constructions.

In order to solve the above technical problem, the present disclosure provides a method and system for tracing a quality of sleeve grouting based on a blockchain and a gathering terminal.

According to an aspect of the present disclosure, there is provided a method for tracing a quality of sleeve grouting based on a blockchain, wherein the method comprises the steps of:

step S1: establishing a unified standard of quality tracing of sleeve-grouting events and a standard of a method of gathering data of the events (including an unified process and an event-data-fingerprint algorithm);

step S2: by using a gathering-terminal module, according to the event-data gathering method, gathering in batch relevant quality tracing information (business data), and accordingly generating a data fingerprint of an event that is capable of ensuring integrity, self-validating ability, non-repudiation and tamper proof of the event;

step S3: performing blockchain distributed bookkeeping to the key quality tracing information of a sleeve-grouting event and the data fingerprint of the event;

step S4: performing blockchain distributed bookkeeping to a result of casual inspection/inspection of the sleeve-grouting event; and

step S5: realizing quality tracing of the sleeve-grouting event based on a unified tracing interface and a safe access policy;

wherein the data fingerprint refers to: data and files that are gathered by the gathering-terminal module based on the event, are related and have different types.

Optionally, the sleeve-grouting event comprises one or more nodes selected from an executing-organization node, a supervising-organization node, a constructing-organization node, an overall-engineering-contracting-organization node, and a regulating-organization node.

Optionally, the step S1 comprises:

encoding unifiedly a prefabricated part, a sleeve and a grouting material (the product); and

identifying unifiedly the prefabricated part, the sleeve and the grouting material by using two-dimensional codes and/or RFIDs.

Optionally, the step S2 comprises:

encoding and describing unifiedly sleeve-grouting events; and

defining intra-blockchain and inter-blockchain tracing interfaces and access protocols of the sleeve-grouting events, wherein the tracing interfaces include an event issuing interface, an event finding interface and an inter-chain-accessing interface.

Optionally, the step S3 comprises:

step S301: uploading to a blockchain distributed ledger the key quality tracing information of the sleeve-grouting events and data fingerprints of the events formed by using a data-fingerprint algorithm; and

step S302: uploading to a blockchain distributed ledger the key quality tracing information of the sleeve-grouting events and data fingerprints of the events formed by using a data-fingerprint algorithm;

wherein the data-fingerprint algorithm refers to an algorithm that ensures that the gathering-terminal module gathers in batch data and files that are related and have different types based on the events and by means of functional units, and the data and files are capable of being identified, recorded and inquired with integrity, self-validating ability, non-repudiation and tamper proof, to verify the integrity and non-repudiation of the event data when tracing information is uploaded to the blockchain, and to verify subsequently the integrity of the inquiring/tracing information and whether the inquiring/tracing information is tampered.

In this step, in an aspect, the key quality tracing information and the data fingerprints of the events ensure the integrity, self-validating ability, non-repudiation and tamper proof of the on-chain data, and, in another aspect, the business data of the events are stored separately, which realizes light weighting of the on-chain tracing of the quality tracing information.

Optionally, the blockchain distributed bookkeeping in the steps S3 and S4 comprises:

establishing and initializing a blockchain, authorizing read-write access permission to the blockchain, analyzing operation data and operation characteristics of an authorized party, and if an abnormal behavior happens, revoking the permission;

keeping an ID, a data fingerprint, a digital signature and a timestamp of the sleeve-grouting event into the blockchain distributed ledger; and

keeping an ID, a digital signature and a timestamp of the sleeve-grouting event into the blockchain distributed ledger;

wherein the blockchain comprises one source-blockchain address and a plurality of destination-blockchain addresses, and the sleeve-grouting event is transmitted from the source-blockchain address to the destination-blockchain addresses via a proprietary network.

Optionally, the step S5 comprises:

by using the unified tracing interfaces and data fingerprints of the events, further accessing the information of the sleeve-grouting events in the business systems, and, by using the data fingerprints of the events, verifying the information obtained from the inquiring with respect to the integrity of the events and whether the information is tampered;

based on the safe access policy, feeding back open information and private information to inquiring parties having different permissions according to different permission settings; and

by using the information involved in the data fingerprints of the events including a photograph, a video or a light-weighting MIB model, using a technique of virtual reality to realize VR three-dimensional scene reproduction, to assist in quality tracing by recalling and reproducing a constructing site.

According to a second aspect of the present disclosure, there is provided a system for tracing a quality of sleeve grouting based on a blockchain, wherein the system comprises:

a tracing-standard module configured to establish a unified standard of quality tracing of sleeve grouting and a standard of a method of gathering data;

a gathering-terminal module configured to gather in batch quality tracing information based on sleeve-grouting events, and form data fingerprints of the events with non-repudiation;

a tracing-information blockchain bookkeeping module configured to perform blockchain distributed bookkeeping to the tracing information of the sleeve-grouting events; and

a unifiedly inquiring and tracing module configured to realize quality tracing of sleeve grouting based on a unified tracing interface and a safe access policy.

Optionally, the quality tracing system further comprises:

a quality tracing BIM module configured to introduce the light-weighting BIM executing model of sleeve grouting into the gathering-terminal module, and simultaneously keep a hash value of the light-weighting BIM executing model into a set of hash values of the sleeve-grouting events.

Optionally, the tracing-information blockchain bookkeeping module is further configured to, based on a multilayer convolutional neural network, perform classification, characteristic extraction, action judgement and authorization controlling to the sleeve-grouting-event tracing information, and use the characteristic data as one of the data bases for the enterprise that it belongs to to make grouting-quality credit rating.

According to a third aspect of the present disclosure, there is provided a gathering-terminal module applied to the system for tracing a quality of sleeve grouting based on a blockchain, wherein the gathering-terminal module comprises:

a recording unit configured to enter grouting-event information;

an auxiliary recording unit configured to assist in recording the grouting-event information;

a proving unit configured to ensure and proving association of the gathered data;

a safety unit configured to ensure safety and reliability of the data uploaded by the gathering-terminal module;

a transmitting unit configured to transmit the grouting-event information from the gathering terminal to the blockchain or the business system; and

an integrity unit configured to ensure integrity and non-repudiation of the event tracing information when the event tracing information is uploaded to the blockchain.

Optionally, the gathering-terminal module is further provided with a data-fingerprint algorithm of events, and is configured to ensure the integrity of the gathered event data and the relation and proving between the data, and, by using the data-fingerprint algorithm, form the data fingerprints of the sleeve-grouting events (a set of hash values of the gathered data that are sorted by the timestamps and are added digital signatures), bind self-certified data (GPS/height/temperature) of the events, add digital signatures, and upload to the blockchain, which ensures the integrity, self-validating ability, non-repudiation and tamper proof of the tracing information when the tracing information is uploaded to the blockchain.

As compared with the prior art, one or more embodiments of the above solutions can have the following advantages or advantageous effects:

(1) The present disclosure can effectively solve the problems in the standard and method of the quality tracing of sleeve grouting, the gathering method and gathering device of the quality tracing information, and the efficiency, safety and regulation and so on in the industrialization of novel constructions.

(2) The present disclosure provides the tracing in the process of constructing and during the full life cycle of constructions of quality information of sleeve grouting.

(3) The present disclosure can realize distributed bookkeeping of the quality tracing information of sleeve grouting in the overall process, to realize the decentralization and tamper proof of the storage of the tracing information.

(4) The present disclosure can, by using the unifiedly inquiring and tracing module, by using the sleeve-grouting-event distributed ledger, realize inquiring and quality tracing based on the safety policy by the quality related parties of the nodes of sleeve grouting, and use a technique of virtual reality to realize VR three-dimensional scene reproduction, to assist in quality tracing by recalling and reproducing a constructing site.

(5) The present disclosure can realize the association of the sleeve-grouting information with the construction designing information, the sleeve (product) information, the grouting material (product) information and the spatial position information of the construction.

(6) The method and system according to the present disclosure can improve the transparency and the quality management in the overall constructing process of prefabricated constructions, and improve the level of management during full life cycle of constructions.

(7) The method and system according to the present disclosure can realize the communication between the blockchains of different enterprises.

The other characteristics and advantages of the present disclosure will be described in the subsequent description, and part of the advantages can become apparent from the description or be understood by the implementation of the present disclosure. The objects and the other advantages of the present disclosure can be realized and obtained from the structures particularly illustrated in the description, the claims and the drawings.

### BRIEF DESCRIPTION OF THE DRAWINGS

The drawings are intended to provide a further understanding of the present disclosure, and constitute part of the description. The drawings are intended to interpret the present disclosure along with the embodiments of the present disclosure, and do not function to limit the present disclosure. In the drawings:

FIG. 1 shows a flow chart of an embodiment of the present disclosure;

FIG. 2 shows a system diagram of an embodiment of the present disclosure; and

FIG. 3 shows a module diagram of the gathering-terminal module according to an embodiment of the present disclosure.

### DETAILED DESCRIPTION

The embodiments of the present disclosure will be described in detail below with reference to the drawings, whereby the implementation process in which the present disclosure applies the technical means to solve the technical problems and achieve the technical effects can be sufficiently understood and accordingly implemented. It should be noted that, subject to the avoiding of any conflict, the embodiments and the features of the embodiments of the present disclosure can be combined, and the technical solutions that are obtained fall within the protection scope of the present disclosure.

Embodiments:

In order to solve the problem in the prior art that, in the field of the industrialization of constructions, the quality tracing in the overall process of constructing of the quality information of sleeve grouting cannot be realized, an embodiment of the present disclosure provides a method and system for tracing a quality of sleeve grouting based on a blockchain and a gathering terminal.

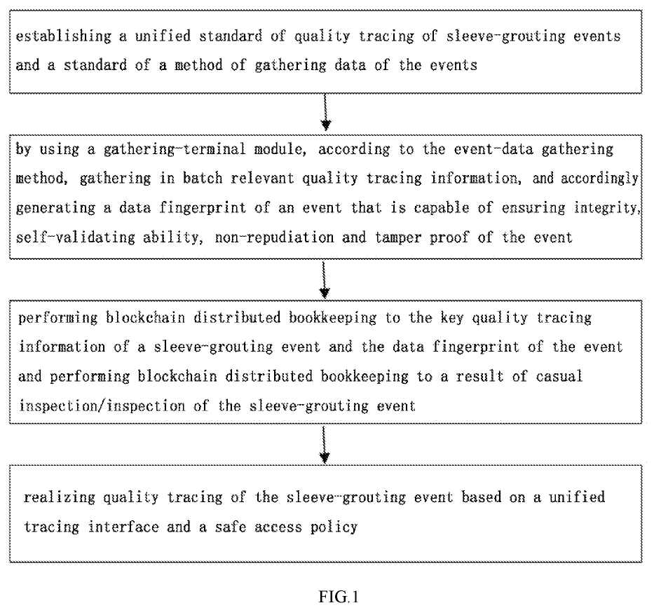

FIG. 1 shows a flow chart of an embodiment of the present disclosure. The method according to the embodiment of the present disclosure comprises:

step S1: establishing a unified standard of quality tracing of sleeve-grouting events and a standard of a method of gathering data of the events (including an unified process and an event-data-fingerprint algorithm);

step S2: by using a gathering-terminal module, according to the event-data gathering method, gathering in batch relevant quality tracing information (business data), and accordingly generating a data fingerprint of an event that is capable of ensuring integrity, self-validating ability, non-repudiation and tamper proof of the event;

step S3: performing blockchain distributed bookkeeping to the key quality tracing information of a sleeve-grouting event and the data fingerprint of the event;

step S4: performing blockchain distributed bookkeeping to a result of casual inspection/inspection of the sleeve-grouting event; and

step S5: realizing quality tracing of the sleeve-grouting event based on a unified tracing interface and a safe access policy.

In the present embodiment, the step S1 comprises:

step S101: encoding unifiedly a prefabricated part, a sleeve and a grouting material, and identifying unifiedly the prefabricated part, the sleeve and the grouting material by using two-dimensional codes and/or RFIDs;

step S102: encoding and describing unifiedly sleeve-grouting events; and

step S201: encoding and describing unifiedly sleeve-grouting events, to form a unifiedly encoding rule of sleeve-grouting events, including mainly the following information:

TABLE 1

| version | | | | prefabricated- | |
|---|---|---|---|---|---|
| number | project ID | project-site ID | grouting site | part ID | note |
| sleeve | grouting- | prefabricated- | BIM executing- | source- | destination- |
| ID | material ID | part-BIM-model | model two- | blockchain | blockchain |
| | | ID | dimensional code | address | address |

The BIM executing-model two-dimensional code is used to download a light-weighting BIM executing model. The source-blockchain address represents the address of the blockchain where the current sleeve-grouting event happens, and the destination-blockchain address represents the address of the blockchain that the current message is required to be transmitted to. The sleeve-grouting event is transmitted from the source-blockchain address to the destination blockchains via a proprietary network, and firstly enters the message queue of the destination blockchains, and the messages in the message queue are transmitted to the destination blockchains in a sequence in which the message coming earlier is processed earlier.

step S202: defining tracing interfaces and access protocols of the sleeve-grouting events.

Particularly, intra-blockchain and inter-blockchain tracing interfaces of the above sleeve-grouting events are defined, and are used to, based on the different safe access policies, feed back open information and private information to inquiring parties according to different permission settings of the inquiring parties.

Particularly, in the present embodiment, the step S2 comprises:

by business personnel, by using the gathering terminal, based on the data gathering method of sleeve-grouting events (including an unified process and an event-data-fingerprint algorithm), ensuring the integrity of the data gathered in the sleeve-grouting events and the relation and proving between the data, and, by using the algorithm, forming the data fingerprints of the sleeve-grouting events (a set of hash values of the gathered data that are sorted by the timestamps), binding self-certified data (GPS/height/temperature) of the events, adding digital signatures, and uploading to the blockchain, which ensures the integrity, reliability and non-repudiation of the tracing information when the tracing information is uploaded to the blockchain; and

after the key quality tracing information of the sleeve-grouting events and the data fingerprints of the events formed by using the data-fingerprint algorithm have been uploaded, according to the practical conditions of the enterprise and the requirements on management, encrypting the business data of the sleeve-grouting events, including sleeve-grouting-event ID, tracing-interface information, safety-policy information, gathering-terminal information, operator information, photographs/videos of the process and so on, and uploading to and storing in a business data/cloud storage.

In an aspect, the key quality tracing information and the data fingerprints of the events ensure the integrity, self-validating ability, non-repudiation and tamper proof of the on-chain data, and, in another aspect, the business data of the events are stored separately, which realizes light weighting of the on-chain tracing of the quality tracing information.

In the present embodiment, the blockchain distributed bookkeeping in the steps S3 and S4 can realize the decentralization and tamper proof of the storage of the tracing information, and comprises:

step S01: by a core enterprise (the authorizing party), establishing and initializing the blockchain. The enterprise may authorize the read-write access permission on the blockchain to other enterprises (the authorized parties), and analyze the operation data and the operation characteristics of the authorized enterprises (the authorized parties) based on a multilayer convolutional neural network every day. If an abnormal behavior happens, the core enterprise (the authorizing party) can revoke the permission at any time.

Particularly, the gathering terminals authenticated by the authorized enterprises (the authorized parties) can write grouting-event tracing information into the blockchain. The predominant enterprise (the authorizing party) issues certificates to the authenticated gathering terminals, and analyzes the operation data and the operation characteristics of the authenticated gathering terminals based on the multilayer convolutional neural network every day. If an abnormal behavior happens, the predominant enterprise (the authorizing party) can revoke the certificate of authority at any time. The information of each of the authenticated gathering terminals can be inquired in the blockchain.

step S02: keeping an ID, a data fingerprint, a digital signature and a timestamp of the sleeve-grouting event into the blockchain distributed ledger. A pair of public key and private key of sleeve-grouting event is simultaneously generated. The public key can be disclosed to all of the nodes, and the private key is not disclosed.

step S03: by the supervising party, by using the private key, reading the relevant sleeve-grouting event, performing casual inspection to it, and keeping the event ID, the supervision-result information, the digital signature and the timestamp of the sleeve-grouting event into the blockchain distributed ledger.

The effective participation of the parties of the quality tracing of sleeve grouting facilitates the formation of closed cycle of the quality tracing information, and also facilitates the effective supervision of the construction quality under the background of the new age.

In the present embodiment, the step S5 comprises:

by using the unified tracing interfaces and data fingerprints of the events, further accessing the information of the sleeve-grouting events in the business systems, and, by using the data fingerprints of the events, verifying the information obtained from the inquiring with respect to the integrity of the events and whether the information is tampered; and, based on the safe access policy, feeding back open information and private information to inquiring parties having different permissions according to different permission settings; and

by using the information involved in the data fingerprints of the events including a photograph, a video or a light-weighting MIB model, using a technique of virtual reality to realize VR three-dimensional scene reproduction, to assist in quality tracing by recalling and reproducing a constructing site.

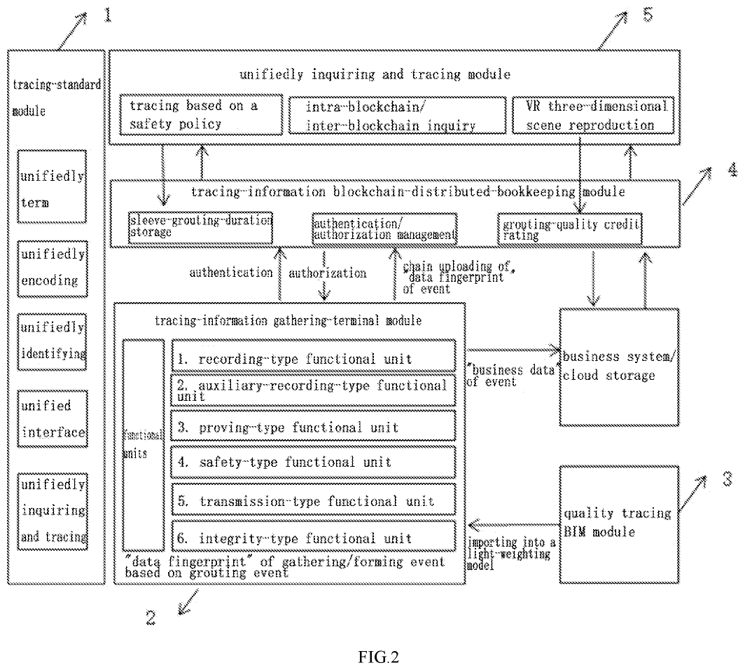

FIG. 2 shows a system diagram of an embodiment of the present disclosure. An embodiment of the present disclosure provides a system for tracing a quality of sleeve grouting based on a blockchain, wherein the system comprises:

a tracing-standard module 1 configured to establish a standard of quality tracing of sleeve grouting and a standard of a method of gathering data in which tracing information is able to be intercommunicated, and including relevant standards for unifying terms, encoding, identifying, interfaces and inquiring/tracing;

a tracing-information gathering-terminal module 2 configured to, based on a sleeve-grouting event, gather and store key tracing information of the process and form a data fingerprint of the event, which ensures the integrity, accuracy and non-repudiation of the tracing information when the tracing information is uploaded to the blockchain;

a quality tracing BIM module 3 configured to introduce the light-weighting BIM executing model into the tracing-information gathering terminal, which can realize the association between the grouting event and the spatial position information of the construction, and at the same time assist in realizing VR three-dimensional scene reproduction;

a tracing-information blockchain bookkeeping module 4 configured to perform blockchain distributed bookkeeping to the key tracing information of sleeve grouting, by using a multilayer convolutional neural network, perform classification, characteristic extraction, authorization controlling and so on to the data gathered by the terminal, and use the characteristic data as one of the data bases for the enterprise that it belongs to to make grouting-quality credit rating; and

a unifiedly inquiring and tracing module 5 configured to realize quality tracing of sleeve grouting based on a unified tracing interface and a safe access policy, and, by using the information involved in the data fingerprint of the grouting event including a photograph, a video or a light-weighting MIB model, realize VR three-dimensional scene reproduction to assist in the quality tracing.

Particularly, the tracing-standard module 1 according to the present embodiment is configured to: encode unifiedly a prefabricated part, a sleeve product and a grouting-material product; identify unifiedly the products by using the technique of Internet of Things (barcode/RFID); encode and describe unifiedly sleeve-grouting events; and define intra-blockchain and inter-blockchain tracing interfaces and access protocols of the sleeve-grouting events, thereby solving the most fundamental problem of standard system of quality tracing, whereby the quality tracing information of sleeve grouting can be intercommunicated.

The quality tracing BIM module 3 according to the present embodiment is configured to introduce the light-weighting BIM executing model into the tracing-information gathering-terminal module, which can realize the association between the grouting event and the spatial position information of the construction, and at the same time assist in realizing VR three-dimensional scene reproduction.

The tracing-information blockchain bookkeeping module 4 according to the present embodiment is configured to save the key quality tracing information of the grouting event into a blockchain system, wherein the blockchain system completes the authentication and authorization of the gathering terminal (merely the gathering terminals that have been authenticated and authorized have the permission of writing into the blockchain), and simultaneously, based on the multilayer convolutional neural network, perform classification, characteristic extraction, action judgement and authorization controlling to the data gathered by the terminal every day, and use the characteristic data as one of the data bases for the enterprise that it belongs to to make grouting-quality credit rating.

The unifiedly inquiring and tracing module 5 according to the present embodiment is configured to, by using intra-blockchain and inter-blockchain tracing interfaces, further access the particular information of the grouting events stored in the business systems of the nodes; and, based on the safe access policy, feed back open information and privacy information to inquirers according to the permission settings; and simultaneously, by using the information involved in the data fingerprint of the grouting events including a photograph, a video or a light-weighting MIB model, use a technique of virtual reality to realize VR three-dimensional scene reproduction, to assist in quality tracing by recalling and reproducing a constructing site.

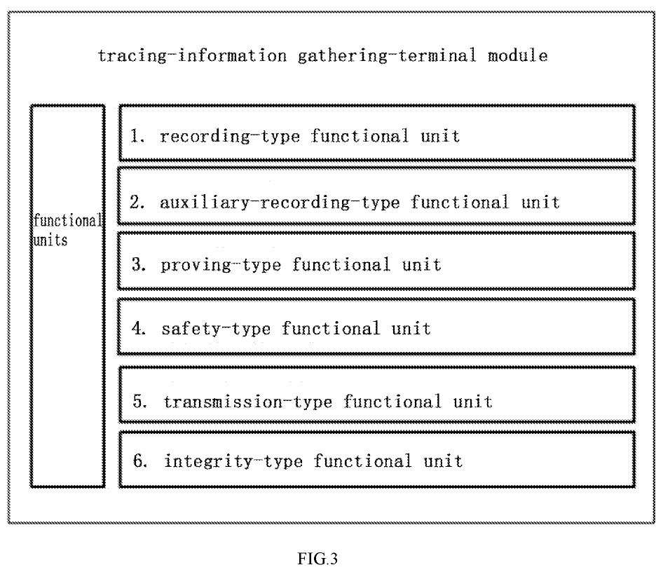

FIG. 3 shows a module diagram of the gathering-terminal module according to an embodiment of the present disclosure. The gathering-terminal module comprises the following functional units:

a recording unit configured to enter grouting-event information;

an auxiliary recording unit configured to assist in recording the grouting-event information;

a proving unit configured to ensure and proving association of the gathered data;

a safety unit configured to ensure safety and reliability of the data uploaded by the gathering-terminal module;

a transmitting unit configured to transmit the grouting-event information from the gathering terminal to the blockchain or the business system; and

an integrity unit configured to ensure integrity and non-repudiation of the event tracing information when the event tracing information is uploaded to the blockchain.

Particularly, the recording unit is configured to enter the grouting-event information (the master data: the grouting site, the engineering project ID, the personnel ID, the key tracing information and the business duration). The auxiliary recording unit is configured to assist in recording the information of the grouting event (the overall amount of the consumption of the grouting-material, the material temperature, the water temperature, the grouting-material temperature, the photographs/videos of the process, and so on). The proving unit is configured to record the consistency between person and certificate (identity card/fingerprint/recognition of face) and (GPS/height/environment temperature) of the grouting-event information. The safety unit is configured for the authorization and authentication and the chip-level encryption of the gathering terminal. The transmitting unit is configured to transmit the grouting-event information from the gathering terminal to the blockchain or the business system. The integrity unit is configured to, by using a data-fingerprint algorithm of the event, ensure integrity and non-repudiation of the event tracing information when the event tracing information is uploaded to the blockchain.

wherein the process of the data gathering method (including the process and the data-fingerprint algorithm) of the gathering-terminal module according to the present embodiment is as follows:

TABLE 2
(I) The process of preparing to record a grouting event:
Logging in with a user ID, and verifying the consistency between person and certificate
(identity card/fingerprint/recognition of face)
Selecting the engineering project, the individual building, the floor and the constructed site
Scanning the two-dimensional code of the sleeve, the two-dimensional code of the grouting
material (product) and the prefabricated-part ID
Associating the prefabricated-part ID and the light-weighting BIM model
Situation of the preparation of the grouted site: photographing/videoing
Stand-by personnel such as constructing/supervising personnel photographing/videoing in
the process of the grouting event
(II) The process of recording the process of the grouting event:
The total amount of the consumption of the grouting-material
The material temperature, the water temperature and the grout temperature The stirring
period and the degree of fluidity
The critical controlling points of the process: photographing/videoing
Stand-by personnel such as constructing/supervising personnel: photographing/videoing
(III) the recording at the end of the grouting event:
The grouting port and the grout discharging port: photographing/videoing
Stand-by personnel such as constructing/supervising personnel: photographing/videoing
(IV) The uploading of the data of the grouting event:
Adding digital signatures to the key tracing information of the grouting event and a data
fingerprint of the grouting event and uploading to the blockchain
Uploading the business data (including the photographs/videos of the processes) of the
grouting event to the business data/cloud storage

The primary functions of the gathering-terminal module are as follows:

by using the functional units, based on the data gathering method of sleeve-grouting events (the gathering process+the data-fingerprint algorithm), gathering in batch relevant quality tracing information (business data), to ensure the integrity of the gathered event data, and the interrelation and proving between the data, and, by using the algorithm, forming data fingerprint of the grouting events (a set of hash values of the gathered data that are sorted by the timestamps), binding self-certified data (GPS/height/temperature) of the events, adding digital signatures, and uploading to the blockchain, which ensures the integrity, reliability and non-repudiation of the tracing information when the tracing information is uploaded to the blockchain.

Particularly, the data-fingerprint algorithm comprises:

based on the events, by means of the functional units, gathering in batch data and files (such as photographs and videos) that are related and have different types, and employing an algorithm that can enable the data and files to be identified, recorded and inquired with integrity, self-validating ability, non-repudiation and tamper proof, to solve the integrity and non-repudiation of the event data when the tracing information is uploaded to the blockchain, and to verify subsequently the integrity of the inquiring/tracing information and whether the inquiring/tracing information is tampered; and

regarding a group (1-N) of different types of data (figures, texts, photographs, videos and so on) gathered in the overall process of the grouting event and an associated light-weighting MIB model, extracting their hash values and stamping timestamps, to form a set of hash values that are sorted by the timestamps, binding self-certified data (GPS/height/temperature) of the event, and adding digital signatures to finally form the data fingerprint of the entire grouting event, which enhances the non-repudiation and tamper proof of the grouting event as a whole.

data fingerprint of the event

| | |
|---|---|
| digital | hash value + GPS/height/temperature + digital-signature |
| signature | timestamp of Data (1-N) |
| | hash value + GPS/height/temperature + digital-signature |
| | timestamp of photograph (1-N) |
| | hash value + GPS/height/temperature + digital-signature |
| | timestamp of video (1-N) |
| | hash value + GPS/height/temperature + digital-signature |
| | timestamp of light-weighting MIB model |

The embodiments of the present disclosure can effectively solve the problems in the standard and method of the quality tracing of sleeve grouting, the gathering method and gathering device of the tracing information, and the efficiency, reliance, safety and regulation and so on in the industrialization of novel constructions, and can support the tracing in the overall process of constructing and tracing during the full life cycle of constructions of the quality tracing information of sleeve grouting.

The particular details of the operations of the above modules can be seen in the above description on the method according to the present disclosure with reference to FIG. 1, and are not discussed here in further detail.

A person skilled in the art should understand that the above-described modules and steps according to the present disclosure may be implemented by using generic computing devices, and they may be concentrated on a single computing device, or be distributed in a network comprising multiple computing devices. Optionally, they may be implemented by using a computer executable program code. Therefore, they may be stored in a storage device and executed by a computing device, or be individually implemented into individual integrated-circuit modules, or some modules or steps among them may be implemented into a single integrated-circuit module. Accordingly, the present disclosure is not limited to any particular combination of hardware and software.

Although the embodiments disclosed by the present disclosure are described above, the descriptions are merely embodiments that are used for facilitating the understanding of the present disclosure, and are not intended to limit the present disclosure. A person skilled in the art can make any modifications and variations with respect to the forms and details of the implementation without departing from the spirit and scope of the present disclosure. However, the protection scope of the present disclosure should be subject to the scope defined by the appended claims.

What is claimed is:

1. A method for tracing a quality of sleeve grouting based on a blockchain, wherein the method comprises the steps of:
step S1: establishing a unified standard of quality tracing of sleeve-grouting events and a standard of a method of gathering data of the events;
step S2: by using a gathering-terminal module, according to the event-data gathering method, gathering in batch relevant quality tracing information, and accordingly generating a data fingerprint of an event that is capable of ensuring integrity, self-validating ability, non-repudiation and tamper proof of the event;
step S3: performing blockchain distributed bookkeeping to the key quality tracing information of a sleeve-grouting event and the data fingerprint of the event;
step S4: performing blockchain distributed bookkeeping to a result of casual inspection/inspection of the sleeve-grouting event; and
step S5: realizing quality tracing of the sleeve-grouting event based on a unified tracing interface and a safe access policy;
wherein the data fingerprint refers to: a set of hash values of data and files that are gathered by the gathering-terminal module based on the event, are sorted by time, are related and have different types, and the hash values have digital signatures.

2. The method for tracing a quality of sleeve grouting based on a blockchain according to claim 1, wherein the sleeve-grouting event comprises one or more nodes selected from an executing-organization node, a supervising-organization node, a constructing-organization node, an overall-engineering-contracting-organization node, and a regulating-organization node.

3. The method for tracing a quality of sleeve grouting based on a blockchain according to claim 1, wherein the step S1 comprises:
encoding unifiedly a prefabricated part, a sleeve and a grouting material; and
identifying unifiedly the prefabricated part, the sleeve and the grouting material by using two-dimensional codes and/or RFIDs.

4. The method for tracing a quality of sleeve grouting based on a blockchain according to claim 1, wherein the step S2 comprises:
encoding and describing unifiedly sleeve-grouting events; and
defining intra-blockchain and inter-blockchain tracing interfaces and access protocols of the sleeve-grouting events, wherein the tracing interfaces include an event issuing interface, an event finding interface and an inter-chain-accessing interface.

5. The method for tracing a quality of sleeve grouting based on a blockchain according to claim 4, wherein the step S3 comprises:
step S301: uploading to a blockchain distributed ledger the key quality tracing information of the sleeve-grouting events and data fingerprints of the events formed by using a data-fingerprint algorithm; and
step S302: uploading the quality tracing information of the sleeve-grouting events to and storing in a business system/cloud storage system;
wherein the data-fingerprint algorithm refers to an algorithm that ensures that the gathering-terminal module gathers in batch data and files that are related and have different types based on the events and by means of functional units, and the data and files are capable of being identified, recorded and inquired with integrity, self-validating ability, non-repudiation and tamper proof, to verify the integrity and non-repudiation of the event data when tracing information is uploaded to the blockchain, and to verify subsequently the integrity of the inquiring/tracing information and whether the inquiring/tracing information is tampered.

6. The method for tracing a quality of sleeve grouting based on a blockchain according to claim 1, wherein the blockchain distributed bookkeeping in the steps S3 and S4 comprises:
establishing and initializing a blockchain, authorizing read-write access permission to the blockchain, analyzing operation data and operation characteristics of an authorized party, and if an abnormal behavior happens, revoking the permission;
keeping an ID, a data fingerprint, a digital signature and a timestamp of the sleeve-grouting event into the blockchain distributed ledger; and
keeping an ID, a digital signature and a timestamp of the sleeve-grouting event into the blockchain distributed ledger;
wherein the blockchain comprises one source-blockchain address and a plurality of destination-blockchain addresses, and the sleeve-grouting event is transmitted from the source-blockchain address to the destination-blockchain addresses via a proprietary network.

7. The method for tracing a quality of sleeve grouting based on a blockchain according to claim 5, wherein the step S5 comprises:
by using the unified tracing interfaces and data fingerprints of the events, further accessing the information of the sleeve-grouting events in the business systems, and, by using the data fingerprints of the events, verifying the information obtained from the inquiring with respect to the integrity of the events and whether the information is tampered;
based on the safe access policy, feeding back open information and private information to inquiring parties having different permissions according to different permission settings; and
by using the information involved in the data fingerprints of the events including a photograph, a video or a light-weighting MIB model, using a technique of virtual reality to realize VR three-dimensional scene reproduction, to assist in quality tracing by recalling and reproducing a constructing site.

8. A system for tracing a quality of sleeve grouting based on a blockchain, wherein the system comprises:
a tracing-standard module configured to establish a unified standard of quality tracing of sleeve grouting and a standard of a method of gathering data;
a gathering-terminal module configured to gather in batch quality tracing information based on sleeve-grouting events, and form data fingerprints of the events with non-repudiation;
a tracing-information blockchain bookkeeping module configured to perform blockchain distributed bookkeeping to the tracing information of the sleeve-grouting events; and
a unifiedly inquiring and tracing module configured to realize quality tracing of sleeve grouting based on a unified tracing interface and a safe access policy.

9. The system for tracing a quality of sleeve grouting based on a blockchain according to claim 8, wherein the quality tracing system further comprises:
a quality tracing BIM module configured to introduce the light-weighting BIM executing model of sleeve grouting into the gathering-terminal module, and simultaneously keep a hash value of the light-weighting BIM executing model into a set of hash values of the sleeve-grouting events.

10. A gathering-terminal module applied to the system for tracing a quality of sleeve grouting based on a blockchain according to claim 8, wherein the gathering-terminal module comprises the following functional units:
a recording unit configured to enter grouting-event information;
an auxiliary recording unit configured to assist in recording the grouting-event information;
a proving unit configured to ensure and proving association of the gathered data;
a safety unit configured to ensure safety and reliability of the data uploaded by the gathering-terminal module;
a transmitting unit configured to transmit the grouting-event information from the gathering terminal to the blockchain or the business system; and
an integrity unit configured to ensure integrity and non-repudiation of the event tracing information when the event tracing information is uploaded to the blockchain.
